(19) United States
(12) Patent Application Publication
(10) Pub. No.: US 2006/0281624 A1
(43) Pub. Date: Dec. 14, 2006

(54) Mixed dispersants containing paste composition and display device including the same

(76) Inventors: Eun-sung Lee, Seoul (KR); Jae-young Choi, Suwon-si (KR); Seon-mi Yoon, Yongin-si (KR); Seul-ki Kim, Goyang-si (KR)

Correspondence Address: CANTOR COLBURN, LLP, 55 GRIFFIN ROAD SOUTH, BLOOMFIELD, CT, 06002, US

(21) Appl. No.: 11/451,661

(22) Filed: Jun. 13, 2006

(30) Foreign Application Priority Data
Jun. 13, 2005 (KR) 10-2005-0050493

(51) Int. Cl. C03C 3/087

(52) U.S. Cl. 501/70

(57) ABSTRACT

A paste composition containing a mix of dispersants includes a dispersant containing a hydrophilic moiety having an acidic functional group; a dispersant containing a hydrophilic moiety having a basic functional group; an inorganic particle; and an organic solvent. The paste composition containing the mixed dispersants according to the present invention has low viscosity due to its excellent dispersibility, and a display device including the exemplary paste composition has an improved filling density.

This application claims priority to Korean Patent Application No. 10-2005-0050493, filed on Jun. 13, 2005, and all the benefits accruing therefrom under 35 U.S.C. §119, and the contents of which in its entirety are herein incorporated by reference.

### BACKGROUND OF THE INVENTION

1. Field of the Invention

The present invention relates to mixed dispersants containing a paste composition and a display device including the same, and more particularly, to a paste composition that contains a dispersant comprising a hydrophilic moiety having an acidic functional group and a dispersant comprising a hydrophilic moiety having a basic functional group, and a display device including the same.

2. Description of the Related Art

Display devices play an important role in conventional information transfer media. Examples of such display devices include monitors of personal computers, TV receivers, and etc. Display devices are classified into cathode ray tubes (“CRTs”) using a high speed thermal electron emission and flat panel displays. The flat panel displays are sub classified into liquid crystal displays (“LCDs”), field emission displays (“FEDs”), and carbon nano tube (“CNTs”) lamps. LCDs are actively being developed.

In a plasma display panel (“PDP”), when a voltage is applied between transparent electrodes, a gas discharge occurs at surfaces of a dielectric layer and a protection layer located on the transparent electrodes, and thus ultraviolet (“UV”) rays are generated. The UV rays excite a phosphor coated on a rear substrate, and thus the phosphor emits light. In a FED or a CNT lamp, when a strong electric field is applied to emitters arranged on a cathode at a predetermined distance from a gate electrode, the emitters emit electrons, and the emitted electrons collide with a phosphor coated on the surface of an anode electrode to emit light.

Despite such different principles of the devices described above, it is common that a phosphor, barrier ribs, and etc. located between panels are coated in a paste state on a substrate when these devices are manufactured. In this case, paste forming components should be uniformly dispersed in the paste and should not precipitate, in order to produce a panel having uniform quality even after a sintering process. A paste having these properties is required to produce other devices used in an electronic field, in addition to flat panel displays. In other words, when the dispersibility is low, it is difficult to obtain uniform electric or magnetic properties after a hardening process, such as a sintering process.

Accordingly, pastes generally include a dispersant to increase dispersibility. For example, a dispersant containing paste composition is disclosed in a number of references, such as Korean Laid-open Publication Nos. 2001-0037347 and 2003-0033564, and Japanese Laid-open Publication No. 2000-203887.

However, conventional paste compositions include only one kind of dispersant. That is, use of a single dispersant results in low viscosity and a desired dispersibility cannot be obtained. In addition, dispersants recently developed are not practical because they have complex designs and high manufacturing costs. Accordingly, there is a need to develop a method of improving dispersibility using conventional dispersants.

### BRIEF SUMMARY OF THE INVENTION

The present invention provides a paste composition containing mixed dispersants.

The present invention also provides a display device including an inorganic device that is prepared by sintering the paste composition containing the mixed dispersants.

According to an exemplary embodiment of the present invention, a paste composition includes a dispersant containing a hydrophilic moiety having an acidic functional group, a dispersant containing a hydrophilic moiety having a basic functional group, an inorganic particle and an organic solvent.

The weight ratio of the dispersant containing a hydrophilic moiety having an acidic functional group to the dispersant containing a hydrophilic moiety having a basic functional group may be in the range of about 100:1 to about 4:1.

The acidic functional group may include at least one group selected from the group consisting of a phosphoric acid group, a carboxy group, a thiocarboxy group, a dithiocarboxy group, a sulfone group, a sulfeno group, a sulfino group, and a hydroxyl group.

Each of the hydrophilic moieties may further have an alkyleneoxide group.

The basic functional group may include at least one group selected from the group consisting of a substituted or unsubstituted amino group, a saturated or unsaturated nitrogen atom containing a heterocyclic alkyl group, and a substituted or unsubstituted nitrogen atom containing a heterocyclic aryl group.

The saturated or unsaturated nitrogen atom containing a heterocyclic alkyl group may include at least one group selected from the group consisting of an imidazolinyl group, a pyrrolidinyl group, an imidazolidinyl group, a pyrazolidinyl group, a piperllidinyl group, a piperazinyl group, an indolidinyl group, and an isoindollenyl group.

The substituted or unsubstituted nitrogen atom containing a heterocyclic aryl group may include at least one group selected from the group consisting of a pyrrollyl group, an imidazolyl group, an isothiazolyl group, an isoxazolyl group, a pyridinyl group, a purinyl group, a pyrazinyl group, a qiunolizinyl group, a pyrimidinyl group, an isoquinolinyl group, a pyridazinyl group, a quinolinyl group, a pyrrolizinyl group, a phthalazinyl group, an indolizinyl group, 1,8-naphthyridinyl group, an isoindolyl group, a quinoxalinyl group, a 3H-indolyl group, a quinazolinyl group, an indolyl group, a cinnolinyl group, an indazolyl group, a pteridinyl group, a 4aH-carbazolyl group, a carbazolyl group, a phenantridinyl group, an acridinyl group, a perimidinyl group, and a phenanthrolinyl group.

The organic solvent may include at least one material selected from the group consisting of terpinol, butylcarbitol, butylcarbitol acetate, pentanediol, dipentene, limonin, ethyleneglycol alkyl ether, diethylene glycol alkyl ether, ethylene glycol alkyl ether acetate, diethyleneglycol alkyl ether acetate, diethyleneglycol dialkyl ether acetate, triethyleneglycol alkyl ether acetate, triethyleneglycol alkyl ether, propylene glycol alkyl ether, propylene glycol phenyl ether, dipropyleneglycol alkylether, tripropyleneglycol alkyl ether, propyleneglycol alkyl ether acetate, dipropyleneglycol alkyl ether acetate, tripropyleneglycol alkyl ether acetate, dimethyl phthalate, diethyl phthalate, dibutyl phthalate, and distilled water.

In the paste composition according to an exemplary embodiment of the present invention, the amount of the organic solvent may be in the range of about 24 parts to about 80 parts by weight and the amount of the dispersants may be in the range of about 0.5 parts to about 3 parts by weight, based on 100 parts by weight of the inorganic particle.

The paste composition may further include an organic binder, wherein the inorganic particle is glass powder.

The glass powder may include at least one material selected from the group consisting of PbO, BaO, SiO₂, B₂O₃, Al₂O₃, ZnO, Bi₂O₃, MgO, Na₂O, K₂O, TiO₂, ZrO₂, CuO, and SnO₂.

The organic binder may include at least one material selected from a cellulose resin, a butyral resin, a polyethylene oxide, acrylate resin, vinyl resin, and a polypropylene carbonate.

The paste composition may further include an additive.

In the paste composition according to another exemplary embodiment of the present invention, the amount of the organic binder may be in the range of about 3 parts to about 6 parts by weight, the amount of the organic solvent may be in the range of about 21 parts to about 74 parts by weight, and the amount of the amount of the dispersants may be in the range of about 0.5 parts to about 3.0 parts by weight, based on 100 parts by weight of the glass powder.

The paste composition may further include about 0.1 parts to about 3 parts by weight of an additive based on 100 parts by weight of the glass powder.

The paste composition may have a viscosity of about 5,000 cps to about 60,000 cps at 25° C. at a shear rate of 1 sec⁻¹.

The paste composition may further include an organic binder, wherein the inorganic particle is a phosphor.

The phosphor may include at least one material selected from the group consisting of YBO₃;Tb, BaMg₁₀Al₁₇:Eu, YGdBO₃:Eu, and Zn₂SiO₄:Mn.

The paste composition may further include an additive.

In the paste composition according to another exemplary embodiment of the present invention, the amount of the organic binder may be in the range of about 3 parts to about 6 parts by weight, the amount of the organic solvent may be in the range of about 21 parts to about 74 parts by weight, and the amount of the dispersants may be in the range of about 0.5 parts to about 3 parts by weight, based on 100 parts by weight of the phosphor.

The paste composition may further include about 0.1 parts to about 3 parts by weight of an additive based on 100 parts by weight of the phosphor.

According to another yet another exemplary embodiment of the present invention, a display device includes an organic device made of the paste composition containing mixed dispersants.

The display device can be a plasma display device.

The display device can be a field emission display device.

According to still another exemplary embodiment of the present invention, a plasma display panel includes the exemplary paste composition as barrier ribs.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a plasma display panel according to an exemplary embodiment of the present invention;

FIG. 2 is a schematic cross-sectional view of an electron emission display device;

FIG. 3 is a graph of an apparent viscosity of paste compositions prepared according to Examples 1 through 3 and a Comparative Example 1;

FIG. 4 is a graph of an apparent viscosity of paste compositions prepared according to an Example 4 and the Comparative Example 1;

FIG. 5 is a graph of an apparent viscosity of paste compositions prepared according to Examples 5 through 7 and a Comparative Example 2; and

FIG. 6 is a graph of an apparent viscosity of paste compositions prepared according to Examples 8 through 11 and the Comparative Example 2.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

A paste composition containing mixed dispersants according to an exemplary embodiment of the present invention has low viscosity due to its excellent dispersibility, and an inorganic device prepared using the paste composition exhibits a high filling density.

The paste composition according to an exemplary embodiment of the present invention includes: a dispersant containing a hydrophilic moiety having an acidic functional group; a dispersant containing a hydrophilic moiety having a basic functional group; an inorganic particle; and an organic solvent. A term of ‘dispersant’ refers to a surfactant that is used for dispersion. It is not necessary that the dispersant be a surfactant. In general, however, the surfactant that exists at the intersurface between the continuous phase particles and the discontinuous phase particles is used as the dispersant because the surfactant provides a repulsive force between discontinuous phase particles dispersed within the continuous phase particles that tend to assemble together. An acidic functional group and a basic functional group are determined according to a degree of tendency of donating hydrogen ions. For example, an acidic functional group can stabilize residual electrons left therein after donation of hydrogen ions in an aqueous solution by, for example, delocalizing the electrons, although the acidic functional group need not dissociate with the hydrogen ions. Although a degree of dissociation of a functional group may be dependent on the entire structure of a molecule to which the functional group is bound, in this specification, it is assumed that molecules, such as hydrogen atoms or methyl groups, to which an acidic functional group and a basic functional group are bound are identical. In particular, an acidic functional group is ready to donate more hydrogen ions, but a basic functional group is ready to withdraw more hydrogen ions.

A dispersant contained in the paste composition according to an exemplary embodiment of the present invention is a mix of dispersants which include a dispersant containing a hydrophilic moiety having an acidic functional group and a dispersant containing a hydrophilic moiety having a basic functional group. Such mixed dispersants is different from a mixed dispersant prepared by simply mixing different kinds of dispersants. In particular, when a mixed dispersant is prepared by simply mixing different dispersants, no interaction occurs between the different dispersants. On the other hand, when a mixed dispersant includes a dispersant containing a hydrophilic moiety having an acidic functional group and a dispersant containing a hydrophilic moiety having a basic functional group, a hydrogen bonding can be formed between the dispersants. Due to this hydrogen bonding, more dispersants exist at the intersurface, the concentration of the dispersant existing in the intersurface increases, and thus an intersurface tension decreases. In addition, a mono molecular layer to be formed may be relatively strong enough to endure collision between particles and have a high density of surface charges. As a result, dispersibitliy of the paste composition increases.

Such mixed dispersants may be mixed in a mixture ratio such that the filling density at the intersurface can be optimized. For example, when one kind of a dispersant exists in an intersurface, gaps may be formed between the identical dispersant molecules. When these gaps are filled with another kind of a dispersant having a relatively small volume, the surface tension can be further decreased. In this case, when the amount of the other kind of the dispersant is too small, these holes are insufficiently filled and thus the intersurface tension decreases. On the other hand, when the amount of the different kind of the dispersant is too large, the entire composition of the dispersant existing in the intersurface changes and thus the intersurface tension rather increases. In consideration of these problems, the amount of the additive is properly determined. According to an exemplary embodiment of the present invention, the weight ratio of the dispersant containing a hydrophilic moiety having an acidic functional group to the dispersant containing a hydrophilic moiety having a basic functional group is in the range of about 100:1 to about 4:1. When the weight ratio is greater than 4:1, the viscosity increases. On the other hand, when the weight ratio is less than 100:1, the viscosity of the paste composition decreases.

The acidic functional group may be selected from a phosphoric acid group, a carboxy group, a thiocarboxy group, a dithiocarboxy group, a sulfone group, a sulfeno group, a sulfino group, and a hydroxyl group, but is not limited thereto. The acidic functional group can be any acidic functional group that is used in the pertinent art.

The hydrophilic moiety may further include an alkyleneoxide group to control hydrophilicity. The alkyleneoxide group may have two to ten carbons. When the alkyleneoxide group has one carbon, synthesizing is difficult, and when the alkyleneoxide group has ten or more carbons, the hydrophilic property may not be obtained.

The basic functional group may be selected from a substituted or unsubstituted amino group, a saturated or unsaturated nitrogen atom containing a heterocyclic alkyl group, and a substituted or unsubstituted nitrogen atom containing a heterocyclic aryl group, but is not limited thereto. The basic functional group can be any basic functional group that is used in the pertinent art.

The saturated or unsaturated nitrogen atom containing a heterocyclic alkyl group may, be selected from an imidazolinyl group, a pyrrolidinyl group, an imidazolidinyl group, a pyrazolidinyl group, a piperilidinyl group, a piperazinyl group, an indolidinyl group, and an isoindollenyl group, but is not limited thereto. The saturated or unsaturated nitrogen atom containing a heterocyclic alkyl group can be any heterocyclic alkyl group that is used in the pertinent art.

The substituted or unsubstituted nitrogen atom containing a heterocyclic aryl group may be selected from a pyrrollyl group, an imidazolyl group, an isothiazolyl group, an isoxazolyl group, a pyridinyl group, a purinyl group, a pyrazinyl group, a qiunolizinyl group, a pyrimidinyl group, an isoquinolinyl group, a pyridazinyl group, a quinolinyl group, a pyrrolizinyl group, a phthalazinyl group, an indolizinyl group, 1,8-naphthyridinyl group, an isoindolyl group, a quinoxalinyl group, a 3H-indolyl group, a quinazolinyl group, an indolyl group, a cinnolinyl group, an indazolyl group, a pteridinyl group, a 4aH-carbazolyl group, a carbazolyl group, a phenantridinyl group, an acridinyl group, a perimidinyl group, and a phenanthrolinyl group, but is not limited thereto. The substituted or unsubstituted nitrogen atom containing a heterocyclic aryl group can be any heterocyclic aryl group that is used in the pertinent art.

The inorganic particle may be, but is not limited to, an inorganic particle that can be dispersed in, for example, an organic solvent, to be in a paste state and used in the pertinent art. The inorganic particle can be an inorganic oxide, a metallic oxide, and etc. In particular, the inorganic particle can be a glass particle, a phosphor particle, a magnetic particle, or the like. Such an inorganic particle is properly selected according to its average particle diameter rather than its chemical composition, in order to be used in a paste state. The average particle diameter (D_{avg}) of the inorganic particle contained in the paste composition according to an exemplary embodiment of the present invention may be about 0.001 μm to about 1000 μm, preferably about 0.01 μm to about 100 μm, and more preferably about 0.1 μm to about 10 μm.

The organic solvent may be selected from terpinol, butylcarbitol, butylcarbitol acetate, pentanediol, dipentene, limonin, ethyleneglycol alkyl ether, diethylene glycol alkyl ether, ethylene glycol alkyl ether acetate, diethyleneglycol alkyl ether acetate, diethyleneglycol dialkyl ether acetate, triethyleneglycol alkyl ether acetate, triethyleneglycol alkyl ether, propylene glycol alkyl ether, propylene glycol phenyl ether, dipropyleneglycol alkylether, tripropyleneglycol alkyl ether, propyleneglycol alkyl ether acetate, dipropyleneglycol alkyl ether acetate, tripropyleneglycol alkyl ether acetate, dimethyl phthalate, diethyl phthalate, dibutyl phthalate, distilled water, and a mixture of these, but is not limited thereto. The organic solvent can be any solvent that can disperse the inorganic particle and is used in the pertinent art.

The paste composition according to an exemplary embodiment of the present invention can be a glass paste composition including glass powder, an organic binder, an organic solvent, and the mixed dispersants described above.

The glass powder can be glass frit having a coefficient of thermal expansion of about 60-10⁻⁷/° C. through about 90-10⁻⁷/° C. (30-300° C.) and having a softening point of about 400° C. to 600° C. In particular, the glass powder may be selected from PbO—SiO₂, PbO—SiO₂—B₂O₃, PbO—SiO₂—B₂O₃—ZnO, PbO—SiO₂—B₂O₃—BaO, PbO—SiO₂—ZnO—BaO, ZnO—SiO₂, ZnO—B₂O₃—SiO₂, ZnO—K₂O—B₂O₃—SiO₂—BaO, Bi₂O₃—SiO₂, Bi₂O₃—B₂O₃—SiO₂, Bi₂O₃—B₂O₃—SiO₂—BaO, ZnO—BaO—B₂O₃—P₂O₅—Na₂O, and Bi₂O₃—B₂O₃—SiO₂—BaO—ZnO.

For example, the PbO—B₂O₃—SiO₂ based glass may have 35-75 wt % of PbO, 0-50 wt % of B₂O₃, 8-30 wt % of SiO₂, 0-10 wt % of Al₂O₃, 0-10 wt % of ZnO, 0-10 wt % of CaO+MgO+SrO+BaO, and 0-6 wt % of SnO₂+TiO₂+ZrO₂.

The BaO—ZnO—B₂O₃—SiO₂ based glass may have 20-50 wt % of BaO, 25-50 wt % of ZnO, 10-35 wt % of B₂O₃, 0-10 wt % of SiO₂, or have 3-25 wt % of BaO, 30-60 wt % of ZnO, 15-35 wt % of B₂O₃, 3-20 wt % of SiO₂, and 1-12 wt % of Li₂O+Na₂O+K₂O.

The ZnO—Bi₂O₃—B₂O₃—SiO₂ based glass may have 2545 wt % of ZnO, 1540 wt % of Bi₂O₃, 10-30 wt % of B₂O₃, 0.5-10 wt % of SiO₂, 0-24 wt % of CaO+MgO+SrO+BaO.

The ZnO—BaO—B₂O₃—P₂O₅—Na₂O based glass may have 30-35 wt % of ZnO, 20-25 wt % of BaO, 30-35 wt % of B₂O₃, 8-12 wt % of P₂O₅, and 3-5 wt % of Na₂O.

The glass frit may be spherical, but is not limited thereto. When the glass frit is spherical, the spherical particle has a better filling property and UV transmission property than a plat or amorphous particle. The glass frit may have an average particle diameter (D_{avg}) of 2 μm to 5 μm, a minimum particle diameter (Dₘᵢₙ) of 0.5 μm, and a maximum particle diameter (Dₘₐₓ) of 10 μm. When D_{avg} is less than 2 μm or Dₘᵢₙ is less than 0.5 μm, the exposure sensitivity decreases, and when a sintering process is performed, more contraction occurs. As a result, a barrier rib of a PDP having a desired form cannot be obtained. On the other hand, when D_{avg} is greater than 5 μm or Dₘₐₓ is greater than 10 μm, accuracy and linearity of the barrier ribs decrease.

As described above, the softening temperature of the glass frit may be in the range of about 400° C. to 600° C. When the softening temperature of the glass frit is less than 400° C., a barrier rib having a desired form cannot be obtained when a sintering process is performed. On the other hand, when the softening temperature of the glass frit is greater than 600° C., the softening occurs insufficiently. In addition, the coefficient of thermal expansion of the glass frit may be almost equal to that of a substrate on which the barrier ribs will be formed because when the difference of the thermal expansion coefficients of the barrier ribs and the substrate is large, the substrate may bend or may be broken.

The glass powder may further include an additive, in addition to pure glass frit. The additive may be a rear earth base oxide, such as La₂O₃ or the like, P₂O₅, MnO, Fe₂O₃, CoO, NiO, GeO₂, Y₂O₃, MoO₃, Rh₂O₃, Ag₂O, In₂O₃, TeO₂, WO₃, ReO₂, VO₅, PdO, or the like. The glass powder may include a ceramic filler, such as alumina, titania (of rutile type and anatase type), zirconia, zircon, α-quartz, quartz glass, and β-quartz solid solution. In particular, when the glass powder is a silica based material, such as α-quartz, a barrier rib having low permitivity can be obtained, and thus, power consumption decreases. Meanwhile, the filling agent may be partly or entirely formed of a spherical filing agent to increase a mechanical strength of the barrier rib.

Accordingly, the glass powder including a glass frit and an additive may include at least one material selected from PbO, BaO, SiO₂, B₂O₃, Al₂O₃, ZnO, Bi₂O₃, MgO, Na₂O, K₂O, TiO₂, ZrO₂, CuO, SnO₂, and the like.

The organic binder may be a cellulose resin, a butyral resin, a polyethylene oxide, a polymethylmetacrylate, a polyacrylate ester, a polypropylene carbonate, or the like, but is not limited thereto. For example, conventional organic binders that are used in the pertinent art can be used alone or in combination in the present exemplary embodiment.

Particularly, the cellulose resin increases the intensity of a dry film and an adhesive force between a substrate and the dry film resist. The cellulose resin may be ethylcellulose, hydroxyethylcellulose, methylcellulose, carboxymethylcellulose, or the like. In particular, an ethylcellulose exhibits a proper paste property for printing or a coating when a barrier rib material layer is formed.

The butyral resin plays a special role in obtaining an adhesive force between the substrate and the dry film resist. When the butyral resin is used together with the cellulose base resin, the adhesive effect of the butyral resin increases. In order to obtain a proper strength and flexibility of the dry film, the butyral resin may have a degree of polymerization of 200 to 1,000 and a weight average molecular weight (M_{w}) of 30,000 to 200,000. Furthermore, in order to improve an adhesive force between the substrate and the dry film, a degree of butyralization may be in the range of 70 mol % to 80 mol %.

The organic binder of the glass paste composition according to an exemplary embodiment of the present invention may be a cellulose resin alone. In another exemplary embodiment, however, the organic binder can be a mixture of the cellulose resin and the butyral resin in a weight ratio of 90:10 to 50:50.

The dispersant of the glass paste composition according to an exemplary embodiment of the present invention may be, in addition to the dispersants described above, menhaden fish oil, polyethyleneimine, glyceryl trioleate, polyacrylic acid, corn oil, glycerin, phosphate ester, or the like.

The glass paste composition according to an exemplary embodiment of the present invention may further include an additive, in addition to the dispersant. The additive may be a plasticizer, such as diethyl oxalate, polyethylene, polyethylene glycol, dimethyl phthalate, dibutyl phthalate, dioctyl phthalate, or the like. In addition, the glass paste composition may further include, as an additive, an antioxidant, a flattening agent, a defoamer, an anti-sagging agent, or the like.

In the glass paste composition according to an exemplary embodiment of the present invention, the amount of the organic binder is in the range of about 3 parts to about 6 parts by weight, the amount of the organic solvent is in the range of about 21 parts to about 74 parts by weight, and the amount of the dispersants is in the range of about 0.5 parts to about 3.0 parts by weight, based on 100 parts by weight of the glass powder.

When the amount of the organic binder is less than 3 parts by weight, the dry film may have fractions and defects after solvent drying. On the other hand, when the amount of the organic binder is greater than 6 parts by weight, the initial viscosity of the organic solution increases significantly, and thus the viscosity of the paste composition increases.

When the amount of the organic solvent is less than 21 parts by weight, the initial viscosity of the organic solution increases significantly, and thus the viscosity of the paste composition increases. On the other hand, when the amount of the organic solvent is greater than 74 parts by weight, the amount of the organic binder is relatively small, and thus the dry film may have fractions and defects after solvent drying.

When the amount of the dispersant is less than 0.5 parts by weight, the inorganic particle is insufficiently dispersed such that the viscosity of the paste composition increases. On the other hand, if the amount of the dispersant is greater than 3 parts by weight, a residual dispersant that is not adsorbed to the surface of the inorganic particle is mixed with a polymer solution, and thus the viscosity of the paste increases.

The glass paste composition according to an exemplary embodiment of the present invention may further include about 0.1 parts to about 3 parts by weight of an additive based on 100 parts by weight of glass powder.

When the amount of the additive is less than 0.1 parts by weight, the dry film may have fractions when dried. On the other hand, when the amount of the additive is greater than 3 parts by weight, the additive may disturb functioning of the dispersant.

The glass paste composition may have a viscosity of about 5,000 cps to about 60,000 cps at 25° C. at a shear rate of 1 sec⁻¹. In particular, when the viscosity of glass paste composition is greater than 60,000 cps, effective printing cannot be obtained. On the other hand, when the viscosity of glass paste composition is less than 5,000 cps, a uniform film cannot be obtained after printing.

The paste composition according to an exemplary embodiment of the present invention can also be a phosphor paste composition including a phosphor, an organic binder, an organic solvent, and a dispersant.

The phosphor of the phosphor paste composition according to another exemplary embodiment of the present invention may be YBO₃:Tb, BaMg₁₀Al₁₇:Eu, YGdBO₃:Eu, Zn₂SiO₄:Mn, or the like. The florescent material may have an average particle diameter of about 0.5 μm to about 5.0 μm. When the average particle diameter of the phosphor is less than 0.5 μm, sufficient optical property cannot be obtained. On the other hand, when the average particle size of the phosphor is greater than 5.0 μm, a nozzle may be clogged.

The phosphor paste composition may include the organic binder and the organic solvent used in the glass paste composition described above.

The phosphor paste composition may further include an additive including a plasticizer, an antioxidant, and a flattening agent.

In the phosphor paste composition, the amount of the organic binder is in the range of about 3 parts to about 6 parts by weight, the amount of the organic solvent is in the range of about 21 parts to about 74 parts by weight, and the amount of the dispersants is in the range of about 0.5 parts to about 3 parts by weight, based on 100 parts by weight of the phosphor.

When the amount of the organic binder is less than 3 parts by weight, the viscosity cannot be controlled. On the other hand, when the amount of the organic binder is greater than 6 parts by weight, an optical efficiency decreases due to actual carbons remaining after sintering.

When the amount of the organic solvent is less than 21 parts by weight, the initial viscosity of the organic solution increases significantly, and thus sufficient printing cannot be obtained. On the other hand, when the amount of the organic solvent is greater than 74 parts by weight, the viscosity of the paste composition decreases.

When the amount of the dispersant is less than 0.5 parts by weight, the inorganic particle is insufficiently dispersed such that the viscosity of the paste composition increases. On the other hand, the amount of the dispersant is greater than 3 parts by weight, the viscosity of the paste composition decreases.

The phosphor paste composition may further include about 0.1 parts to about 3 parts by weight of an additive based on 100 parts by weight of the phosphor.

When the amount of the additive is less than 0.1 parts by weight, the strength of the formed film decreases and thus the film has fractions and depressions due to thermal stress generated when dried. On the other hand, when the amount of the additive is greater than 3 parts by weight, the initial viscosity of the organic solvent is high and thus particles cannot disperse.

A display device according to an exemplary embodiment of the present invention includes a sintered product produced from the paste composition described above through sintering and processing. The sintered product is an inorganic device having an improved filling density. That is, a slurry having a greater amount of inorganic particles at the same viscosity can be prepared, and thus, when such a slurry is sintered, a sintered product, that is an inorganic device, having an improved filling density can be obtained. According to an exemplary embodiment of the present invention, the sintered product can be a barrier rib or phosphor for a plasma display panel (“PDP”). The barrier rib and phosphor may be formed from the paste composition through drying and sintering processes, and can be produced using methods known in the art. For example, barrier ribs of a PDP may be produced using a screen printing method, a sand blasting method, an additive method, a photosensitive paste method, and a low temperature cofired ceramic on metal (“LTCCM”) method, or the like.

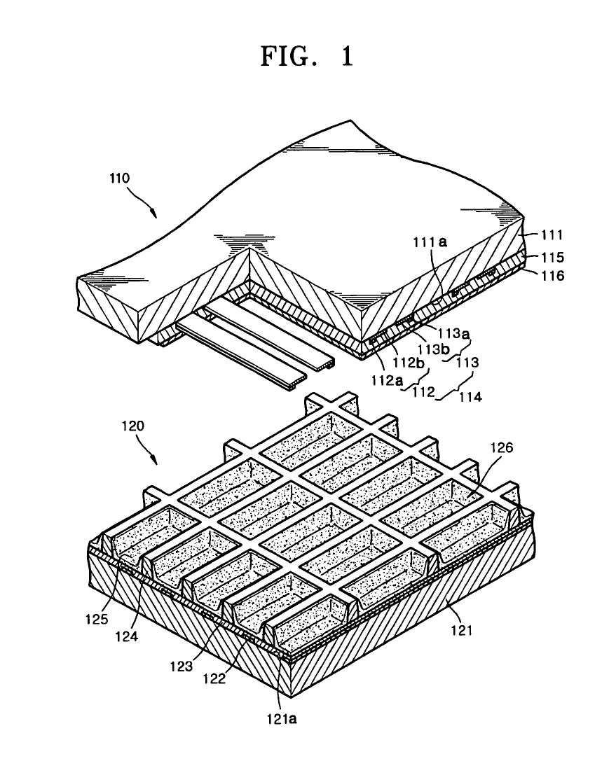

A display device according to an exemplary embodiment of the present invention includes a sintered product produced by sintering the paste composition described above. The display device can be a PDP. The PDP has a structure illustrated in FIG. 1. A method of manufacturing the PDP will now be described. First, pairs of patterned electrodes 114 including X electrodes 113 and Y electrodes 112 are formed on a front glass substrate 111. After bus electrodes 113a are formed, a transparent dielectric layer 115 that protects the pairs of electrodes 114 is formed, and then a protection layer 116 formed of MgO is formed on the transparent dielectric layer 115. As a result, a front substrate 110 is manufactured.

In order to manufacture a rear substrate 120, patterned address electrodes 122 are formed on a rear glass substrate 121, and then the address electrodes 122 are covered with a dielectric layer 123. In order to form barrier ribs 124, the paste composition according to an exemplary embodiment of the present invention is coated on the entire surface of the dielectric layer 123, dried, and then patterned using a sand blasting method to obtain a desired barrier shape. Thereafter, a phosphor layer 125 is printed and sintered.

In order to manufacture the PDP, a sealing material is doped onto the peripheries of the front glass substrate 111 and the rear glass substrate 121 using a dispenser, the resulting front and rear glass substrates 111 and 121 are coupled such that they face each other and then are panelized with each other, the inside of the PDP is discharged, a discharge space of the PDP is filled with a discharge gas, such as Ne or He—Xe, and sealed. The glass paste composition can also be used to produce other display devices.

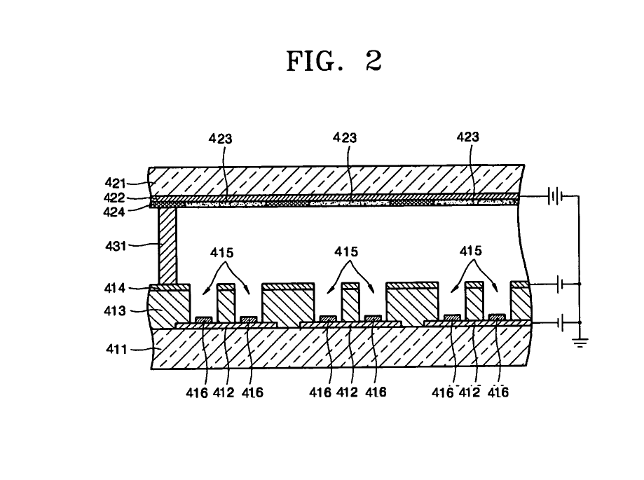

A display device according to another exemplary embodiment of the present invention is an electron emission display device. The electron emission display device has a structure illustrated in FIG. 2. In particular, the electron emission display device has a three-electrode structure of a cathode 412, an anode 422, and a gate electrode 414. A method of manufacturing the electron emission display device will be described. First, the cathode 412 and the gate electrode 414 are formed on a rear substrate 411 with emitters 416. The anode 422 is formed on a lower surface of a front substrate 421. A phosphor layer 423 prepared from the phosphor paste composition according to an exemplary embodiment of the present invention and a black matrix 424 used to improve contrast are formed on a lower surface of the anode 422. An insulating layer 413 having fine openings 415 and the gate electrode 414 are formed on the cathode 412. Thereafter, a spacer 431 is located between the rear substrate 411 and the front substrate 421 such that the rear substrate 411 is separated from the front substrate 421 by a predetermined distance. The display device including the sintered product prepared by sintering the paste composition is not limited to the display devices described above. Such a display device can be any display device that is used in the art, for example, a PDP including barrier ribs prepared by sintering the paste composition.

The present invention will be described in further detail with reference to the following examples. These examples are for illustrative purposes only and are not intended to limit the scope of the present invention.

Manufacturing of Glass Paste Composition

### EXAMPLE 1

37.69 g of glass powder having 85 wt % of glass frit (ZnO 35 wt %, BaO 20 wt %, B₂O₃ 30 wt %, and P₂O₅ 12 wt %), 5 wt % of ZnO, and 10 wt % of Al₂O₃; 1.93 g of ethylcellulose; 8.68 g of terpineol; 8.68 g of butylcarbitolacetate; 0.4 g of dibutylphthalate; 0.36 g of oleic acid; and 0.02 g of oleylamine were mixed, stirred by a stirrer, and pasted by a 3-roll mill to prepare a glass paste composition. In this case, glass powder was added after a vehicle was prepared by mixing vehicle components.

### EXAMPLE 2

A glass paste composition was prepared in the same manner as in Example 1, except that 0.34 g of an oleic acid and 0.04 g of oleylamine were used instead of 0.36 g of the oleic acid and 0.02 g of oleylamine.

### EXAMPLE 3

A glass paste composition was prepared in the same manner as in Example 1, except that 0.3 g of an oleic acid and 0.08 g of oleylamine were used instead of 0.36 g of the oleic acid and 0.02 g of oleylamine.

### EXAMPLE 4

A glass paste composition was prepared in the same manner as in Example 1, except that 0.3 g of an oleic acid and 0.08 g of imidazole (Product Name: Unamine O, produced by Lonza Inc.) were used instead of 0.36 g of the oleic acid and 0.02 g of oleylamine.

### EXAMPLE 5

A glass paste composition was prepared in the same manner as in Example 1, except that 0.36 g of phosphate ester (Product Name: Disperbyk 111, produced by BYK-chemie Inc.) and 0.02 g of oleylamine were used instead of 0.36 g of the oleic acid and 0.02 g of oleylamine.

### EXAMPLE 6

A glass paste composition was prepared in the same manner as in Example 1, except that 0.34 g of phosphate ester (Product Name: Disperbyk 111, produced by BYK-chemie Inc.) and 0.04 g of oleylamine were used instead of 0.36 g of the oleic acid and 0.02 g of oleylamine.

### EXAMPLE 7

A glass paste composition was prepared in the same manner as in Example 1, except that 0.3 g of phosphate ester (Product Name: Disperbyk 111, produced by BYK-chemie Inc.) and 0.08 g of oleylamine were used instead of 0.36 g of the oleic acid and 0.02 g of oleylamine.

### EXAMPLE 8

A glass paste composition was prepared in the same manner as in Example 1, except that 0.36 g of phosphate ester (Product Name: Disperbyk 111, produced by BYK-chemie Inc.) and 0.02 g of imidazole (Product Name: Unamine O, produced by Lonza Inc.) were used instead of 0.36 g of the oleic acid and 0.02 g of oleylamine.

### EXAMPLE 9

A glass paste composition was prepared in the same manner as in Example 1, except that 0.34 g of phosphate ester (Product Name: Disperbyk 111, produced by BYK-chemie Inc.) and 0.04 g of imidazole (Product Name: Unamine O, produced by Lonza Inc.) were used instead of 0.36 g of the oleic acid and 0.02 g of oleylamine.

### EXAMPLE 10

A glass paste composition was prepared in the same manner as in Example 1, except that 0.32 g of phosphate ester (Product Name: Disperbyk 111, produced by BYK-chemie Inc.) and 0.06 g of imidazole (Product Name: Unamine O, produced by Lonza Inc.) were used instead of 0.36 g of the oleic acid and 0.02 g of oleylamine.

### EXAMPLE 11

A glass paste composition was prepared in the same manner as in Example 1 except that 0.3 g of phosphate ester (Product Name: Disperbyk 111, produced by BYK-chemie Inc.) and 0.08 g of imidazole (Product Name: Unamine O, produced by Lonza Inc.) were used instead of 0.36 g of the oleic acid and 0.02 g of oleylamine.

### COMPARATIVE EXAMPLE 1

A glass paste composition was prepared in the same manner as in Example 1, except that 0.38 g of an oleic acid alone was used instead of 0.36 g of the oleic acid and 0.02 g of an oleylamine.

### COMPARATIVE EXAMPLE 2

A glass paste composition was prepared in the same manner as in Example 1, except that 0.377 g of a phosphate ester (Product Name: Disperbyk 111, produced by BYK-chemie Inc.) alone was used instead of 0.36 g of the oleic acid and 0.02 g of an oleylamine.

Manufacturing of Barrier Ribs of PDP

### EXAMPLE 13

The glass paste composition prepared according to Example 1 was coated on a substrate to a thickness of about 150 μm and then dried. Then, a dry film resister (“DFR”) was laminated on the surface of the glass paste composition by pressing the surface of the glass paste composition using a roll such that the glass paste composition could be selectively removed through a later sand blasting process. In particular, the DFR was exposed and developed to form a blast mask pattern, and then, the sand blasting process, in which sand was sprayed at high rate under a high pressure, was performed to abrade a portion that was not shielded by the blast mask pattern. As a result, barrier ribs are formed. Then, the blast mask pattern was removed and the resulting structure was sintered at 480-500° C. for 30 minutes. The barrier ribs could be manufactured from the glass paste composition within two hours.

### COMPARATIVE EXAMPLE 4

Barrier ribs were manufactured in the same manner as in Example 13, except that the glass paste composition prepared according to Comparative Example 1 was used instead of the glass paste composition prepared according to Example 1.

### EXPERIMENT EXAMPLE 1

### Viscosity Test—Glass Paste Composition

Dispersibility of a paste composition with respect to a dispersant was measured by measuring viscosities of the glass paste compositions prepared according to Examples 1 through 11 and Comparative Examples 1 and 2. At this time, a brookfield viscometer RVII was used as a viscometer, a spindle #14 of a cylinder type was used as a spindle, and the temperature was 25° C. The test results are shown in Table 1.

TABLE 1

| | Shear Rate | | | | | | | | | |
|---|---|---|---|---|---|---|---|---|---|---|
| | 0.2/sec | 0.4/sec | 0.8/sec | 1.0/sec | 1.6/sec | 2/sec | 4/sec | 8/sec | 20/sec | 40/sec |
| Example 1 | 15000 | 13750 | 12500 | 12500 | 12188 | 12000 | 11500 | 11063 | 10250 | 9575 |
| Example 2 | 15000 | 12500 | 11875 | 11500 | 10938 | 10750 | 10375 | 9938 | 9325 | 8700 |
| Example 3 | 17500 | 15000 | 11875 | 11500 | 10313 | 10000 | 9250 | 8688 | 8075 | 7525 |
| Example 4 | — | — | — | — | — | — | — | — | — | — |
| Example 5 | — | — | — | — | — | 6250 | 6000 | 5800 | — | — |
| Example 6 | — | — | — | — | — | 6500 | 6250 | 6100 | — | — |
| Example 7 | — | — | — | — | — | 7250 | 6750 | 6375 | — | — |
| Example 8 | — | — | — | — | — | — | | 7063 | — | — |
| Example 9 | — | — | — | — | — | — | | 7750 | — | — |
| Example 10 | — | — | — | — | — | — | | 8063 | — | — |
| Example 11 | | | | | | | | 8563 | | |
| Comparative | 15000 | 15000 | 13750 | 13500 | 12813 | 12750 | 12625 | 12375 | 11675 | 10725 |
| Example 1 | | | | | | | | | | |
| Comparative | | | | | | 6500 | 6500 | 6313 | | |
| Example 2 | | | | | | | | | | |

(Unit: cps)

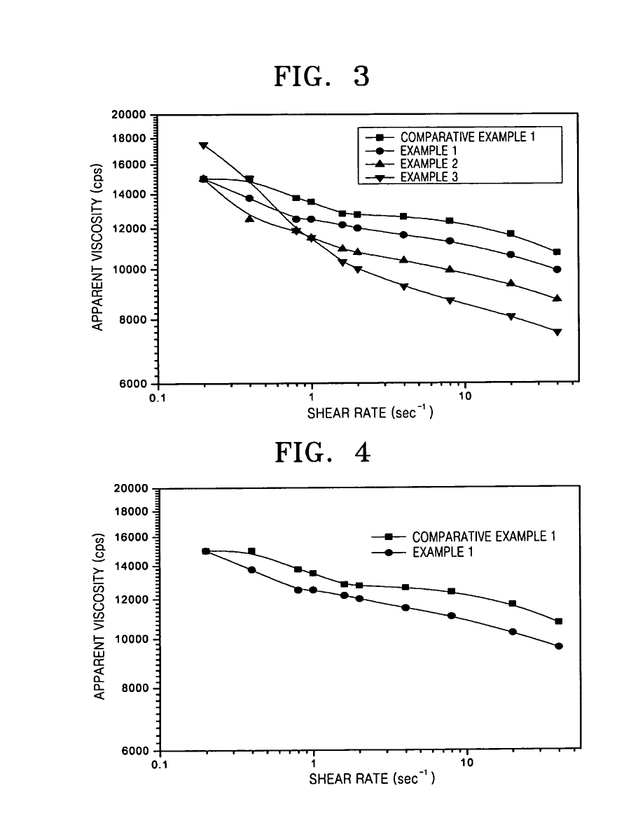

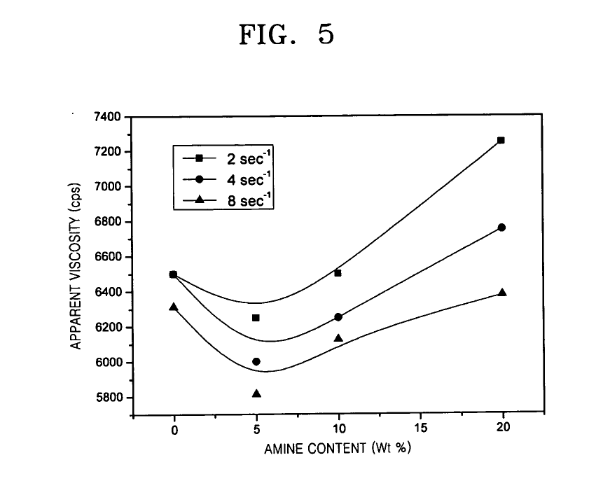

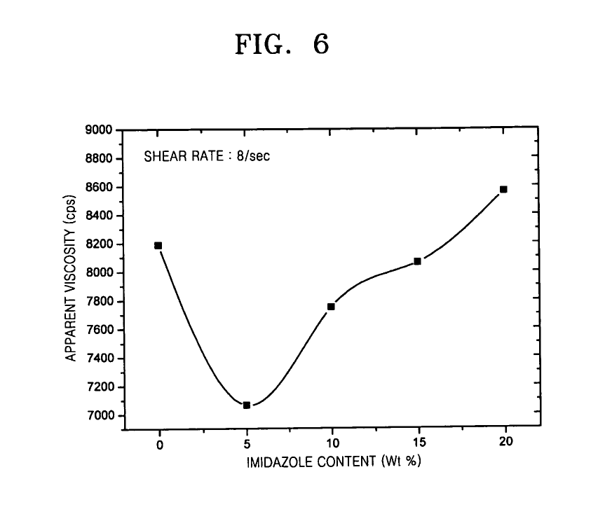

As shown in Table 1, the paste composition prepared according to Examples 1 through 11 exhibited relatively lower viscosity than the paste compositions prepared according to Comparative Examples 1 and 2 when the shear rate was greater than 1/sec. As apparent from Examples 1 through 4, when the concentration of a surfactant having a basic functional group was 20 wt %, the viscosity was relatively low. As apparent from Examples 5 through 11, when a dispersant including a basic functional group is in the range of 1-10 wt %, the viscosity was relatively low. Such a decrease of viscosity may result from a high density of mixed dispersants including a dispersant containing a hydrophilic moiety having an acidic functional group and a dispersant containing a hydrophilic moiety having a basic functional group at an interface due to a hydrogen binding between the dispersants. In particular, the viscosity was lowest at a specific mixture ratio. The test results are shown in FIGS. 3 through 6.

A paste composition containing mixed dispersants according to the present invention has low viscosity due to its excellent dispersibility, and a display device including the exemplary paste composition has an improved filling density.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A paste composition comprising:
a dispersant containing a hydrophilic moiety having an acidic functional group;
a dispersant containing a hydrophilic moiety having a basic functional group;
an inorganic particle; and
an organic solvent.

2. The paste composition of claim 1, wherein the weight ratio of the dispersant containing a hydrophilic moiety having an acidic functional group to the dispersant containing a hydrophilic moiety having a basic functional group is in the range of about 100:1 to about 4:1.

3. The paste composition of claim 1, wherein the acidic functional group comprises at least one group selected from the group consisting of a phosphoric acid group, a carboxy group, a thiocarboxy group, a dithiocarboxy group, a sulfone group, a sulfeno group, a sulfino group, and a hydroxyl group.

4. The paste composition of claim 1, wherein each of the hydrophilic moieties further has an alkyleneoxide group.

5. The paste composition of claim 1, wherein the basic functional group comprises at least one group selected from the group consisting of a substituted or unsubstituted amino group, a saturated or unsaturated nitrogen atom containing a heterocyclic alkyl group, and a substituted or unsubstituted nitrogen atom containing a heterocyclic aryl group.

6. The paste composition of claim 5, wherein the saturated or unsaturated nitrogen atom containing a heterocyclic alkyl group comprises at least one group selected from the group consisting of an imidazolinyl group, a pyrrolidinyl group, an imidazolidinyl group, a pyrazolidinyl group, a piperilidinyl group, a piperazinyl group, an indolidinyl group, and an isoindollenyl group.

7. The paste composition of claim 5, wherein the substituted or unsubstituted nitrogen atom containing a heterocyclic aryl group comprises at least one group selected from the group consisting of a pyrrollyl group, an imidazolyl group, an isothiazolyl group, an isoxazolyl group, a pyridinyl group, a purinyl group, a pyrazinyl group, a qiunolizinyl group, a pyrimidinyl group, an isoquinolinyl group, a pyridazinyl group, a quinolinyl group, a pyrrolizinyl group, a phthalazinyl group, an indolizinyl group, 1,8-naphthyridinyl group, an isoindolyl group, a quinoxalinyl group, a 3H-indolyl group, a quinazolinyl group, an indolyl group, a cinnolinyl group, an indazolyl group, a pteridinyl group, a 4aH-carbazolyl group, a carbazolyl group, a phenantridinyl group, an acridinyl group, a perimidinyl group, and a phenanthrolinyl group.

8. The paste composition of claim 1, wherein the organic solvent comprises at least one material selected from the group consisting of terpinol, butylcarbitol, butylcarbitol acetate, pentanediol, dipentene, limonin, ethyleneglycol alkyl ether, diethylene glycol alkyl ether, ethylene glycol alkyl ether acetate, diethyleneglycol alkyl ether acetate, diethyleneglycol dialkyl ether acetate, triethyleneglycol alkyl ether acetate, triethyleneglycol alkyl ether, propylene glycol alkyl ether, propylene glycol phenyl ether, dipropyleneglycol alkylether, tripropyleneglycol alkyl ether, propyleneglycol alkyl ether acetate, dipropyleneglycol alkyl ether acetate, tripropyleneglycol alkyl ether acetate, dimethyl phthalate, diethyl phthalate, dibutyl phthalate, and distilled water.

9. The paste composition of claim 1, wherein the amount of the organic solvent is in the range of about 24 parts to about 80 parts by weight and the amount of the dispersants is in the range of about 0.5 parts to about 3 parts by weight, based on 100 parts by weight of the inorganic particle.

10. The paste composition of claim 1, further comprising an organic binder, wherein the inorganic particle is glass powder.

11. The paste composition of claim 10, wherein the glass powder comprises at least one material selected from the group consisting of PbO, BaO, SiO₂, B₂O₃, Al₂O₃, ZnO, Bi₂O₃, MgO, Na₂O, K₂O, TiO₂, ZrO₂, CuO, and SnO₂.

12. The paste composition of claim 10, wherein the organic binder comprises at least one material selected from the group consisting of a cellulose resin, a butyral resin, a polyethylene oxide, an acrylate resin, a vinyl resin, and a polypropylene carbonate.

13. The paste composition of claim 10, further comprising an additive.

14. The paste composition of claim 10, wherein the amount of the organic binder is in the range of about 3 parts to about 6 parts by weight, the amount of the organic solvent is in the range of about 21 parts to about 74 parts by weight, and the amount of the dispersants is in the range of about 0.5 to about 3.0 parts by weight, based on 100 parts by weight of the glass powder.

15. The paste composition of claim 14, further comprising about 0.1 parts to about 3 parts by weight of an additive based on 100 parts by weight of the glass powder.

16. The paste composition of claim 1, further comprising an organic binder, wherein the inorganic particle is a phosphor.

17. The paste composition of claim 16, wherein the phosphor comprises at least one material selected from the group consisting of YBO₃;Tb, BaMg₁₀Al₁₇:Eu, YGdBO₃:Eu, and Zn₂SiO₄:Mn.

18. The paste composition of claim 16, further comprising an additive.

19. The paste composition of claim 16, wherein the amount of the organic binder is in the range of about 3 parts to about 6 parts by weight, the amount of the organic solvent is in the range of about 21 parts to about 74 parts by weight, and the amount of the dispersants is in the range of about 0.5 parts to about 3 parts by weight, based on 100 parts by weight of the phosphor.

20. The paste composition of claim 19, further comprising about 0.1 parts to about 3 parts by weight of an additive based on 100 parts by weight of the phosphor.

21. A display device comprising an inorganic device made of a paste composition, the paste composition comprising
a dispersant containing a hydrophilic moiety having an acidic functional group;
a dispersant containing a hydrophilic moiety having a basic functional group;
an inorganic particle;
an organic solvent; and
an organic binder,
wherein the inorganic particle is glass powder.

22. The display device of claim 21, wherein the display device is a plasma display device.

23. The display device of claim 21, wherein the display device is a field emission display device.

24. A plasma display panel comprising barrier ribs formed using a paste composition, the paste composition comprising
a dispersant containing a hydrophilic moiety having an acidic functional group;
a dispersant containing a hydrophilic moiety having a basic functional group;
an inorganic particle;
an organic solvent; and
an organic binder,
wherein the inorganic particle is glass powder.
